(19) United States
(12) Patent Application Publication
(10) Pub. No.: US 2005/0108635 A1
(43) Pub. Date: May 19, 2005

(54) Document processing apparatus and storage medium

(75) Inventor: Tsuyahiko Shimada, Maebashi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/784,977

(22) Filed: Feb. 25, 2004

(30) Foreign Application Priority Data
May 30, 2003 (JP) 2003-155278

(51) Int. Cl. G06F 17/00

(52) U.S. Cl. 715/518

(57) ABSTRACT

An area on an image of a document indicated by image data of an obtained document is discriminated between two types of areas, that is, a useful information area considered to include useful information and an useless information area considered not to include useful information, and a row to be thinned is specified. The position of an entry column recognized by referring to the image data of the obtained document is corrected based on the specified row to be thinned. Based on the row to be thinned, a recognition result of an entry column, etc., an operation is performed on the image data and the resultant image data is displayed.

### BACKGROUND OF THE INVENTION

1. Field of the Invention

The present invention relates to the technology of digitizing a document such as a questionnaire form, an examination paper, etc.

2. Description of the Related Art

Resultant answers written to questionnaire forms have to be summed with regard to respective questions, and answers written to answer paper have to be checked with regard to respective questions. Thus, a collected document is to be processed with laborious work. Therefore, there have recently been a number of documents having a plurality of mark entry columns for each question so that an answer can be selected from one of the plurality of entry columns and a mark is written to the selected entry column.

In this system, a marked entry column, that is, an answer or the contents of an answer can be automatically recognized by reading the image of the document. Therefore, a collected document can be more easily and quickly processed. Thus, it is assumed for convenience in the following explanation that a document is a questionnaire form.

The stains, the gray level of a mark, etc. can be the causes of misrecognition by misrecognizing a mark which is not actually entered, by failing to recognizing an entered mark, etc. Thus, an operator checks whether or not recognition is being correctly performed so that an incorrect recognition result can be corrected.

The document processing apparatus is used in the correcting process, etc. In the document processing apparatus, based on the image of a document (document image) displayed on the display device, the operator checks the presence/absence of misrecognition so that misrecognized contents can be corrected. As a result, most document processing apparatus is provided with a document display device on which the image of the document is displayed.

To more quickly check the presence/absence of misrecognition, it is desired that the ratio of the portion of the image of a document displayed on one screen can be largest possible. It is the most desirable that the entire image can be displayed on one screen. However, the entire image of a document is not always displayed on one screen.

The conventional method for displaying on one screen an image which cannot be entirely displayed on one screen is to reduce the image such that the image can be displayed on one screen. FIG. 1 shows an image of a document by vertically reducing the image. FIG. 6 shows the original image before the vertical reduction.

As shown in FIG. 1, when an image is reduced, the included characters are reduced correspondingly. Therefore, it is hard to read the characters, that is, the visual recognizability is reduced. The reduction in visual recognizability disables a quick check, thereby requiring a longer time in a correcting operation. Thus, it is important to prevent the reduction in visual recognizability when a larger portion is displayed.

### SUMMARY OF THE INVENTION

The first object of the present invention is to provide a document processing apparatus capable of displaying on one screen a largest possible portion of an image of a document with the reduction in visual recognizability suppressed.

The second object of the present invention is to provide a document processing apparatus capable of always quickly correcting a recognition result.

The first aspect of the document processing apparatus according to the present invention displays a document image using image data of a document having one or more entry columns, and includes: an image data obtaining unit for obtaining image data of a document; an area discrimination unit for discriminating an area of a document image indicated by the image data obtained by the image data obtaining unit, and discriminating at least between two types of areas, that is, a useful information area having useful information for document processing and an useless information area having no useful information area; a data processing unit for increasing the ratio of the useful information area to the entire area by processing at least one of the first partial image data which is the image data of the portion for display of a useful information area and the second partial image data which is the image data of the portion for display of an useless information area; and a display control unit for displaying a document image on the display device using the image data obtained by the data processing unit processing at least one of the first and second partial image data.

It is desired that the area discrimination unit considers at least one direction in counting the number of pixels assumed to be used in displaying information about the document image represented by the image data, and discriminates a useful information area from an useless information area based on a counting result.

It is also desired that when the area discrimination unit discriminates a useful information area from an useless information area based on whether or not the number of pixels counted by considering one direction is equal to or smaller than a predetermined value, the data processing unit increases the ratio of the useful information area to the entire area by performing on at least the second partial image data the process of thinning the lines having the number of pixels equal to or smaller than a predetermined value in the lines in the above-mentioned one direction.

The document processing apparatus according to the second aspect of the present invention processes a document having one or more entry columns, and includes in addition to the configuration according to the first aspect of the document processing apparatus: a document recognition unit for recognizing an entry column entered on a document image displayed by the display control unit; and a correction unit for correcting the presence/absence of an entry in an entry column recognized by the document recognition unit at an instruction of a user.

The storage media according to the first and second aspect of the present invention respectively stores the programs having a plurality of functions for realizing the configuration of the first and second aspects of the document processing apparatus.

In the present invention, an area on a document image displayed by obtained image data is discriminated and classified into at least two areas, that is, a useful information area containing useful information for document processing and an useless information area containing no useful information. In the image data, a process for increasing the ratio of the useful information area to the entire area is performed on at least one of the first partial image data which is image data for display of a useful information area and the second partial image data which is image data for display of an useless information area. A document image is displayed on the display device using the processed image data.

When the document image is displayed as described above, the most of the useful information area can be displayed with the reduction of visual recognizability suppressed. As a result, a recognition result of a mark, etc. entered in an entry column can be more easily and quickly corrected.

### BRIEF DESCRIPTION OF THE DRAWINGS

FIG. 1 is an explanatory view of an image of a document when the document is reduced in the vertical direction according to a conventional method;

FIG. 2 is an explanatory view of the configuration of the document processing system using a document processing apparatus according to an embodiment of the present invention;

FIG. 3 shows the configuration of the computer shown in FIG. 2;

FIG. 4 shows the configuration indicating the function of the document processing apparatus according to an embodiment of the present invention;

FIG. 5 is an explanatory view of the image of a document displayed by the document processing apparatus according to an embodiment of the present invention;

FIG. 6 is an explanatory view of the data stored in a mark recognition result table;

FIG. 7 is an explanatory view of the configuration of a histogram table;

FIG. 8 is an explanatory view of the data stored in a histogram table;

FIG. 9 is an explanatory view showing the contents of the operation depending on the method of checking a useful information area and on the area;

FIG. 10 is an explanatory view showing the contents for update of a mark recognition result table;

FIG. 11 is an explanatory view showing the image of a document practically displayed by the document processing apparatus according to an embodiment of the present invention;

FIG. 12 is a flowchart of the mark recognizing process on a document;

FIG. 13 is a flowchart of the density converting process;

FIG. 14 is a flowchart of the histogram table generating process;

FIG. 15 is a flowchart of the image position correcting process;

FIG. 16 is a flowchart of the detection position correcting process; and

FIG. 17 is a flowchart of the correcting process.

### DESCRIPTION OF THE PREFERRED EMBODIMENTS

The embodiments of the present invention are described below by referring to the attached drawings.

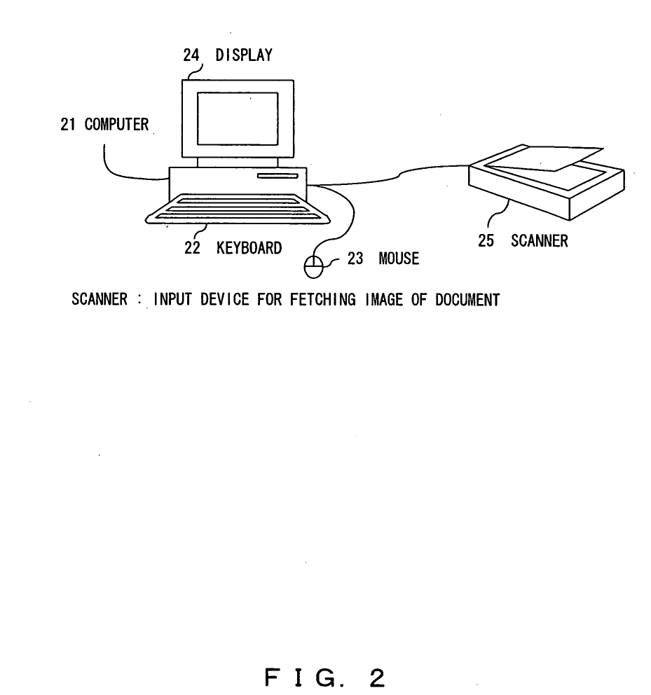

FIG. 2 shows the configuration of the document processing system generated using the document processing apparatus according to the present embodiment.

The system is formed by connecting a keyboard 22, a mouse 23, a display 24, and a scanner 25 to the body of a computer 21. The document processing apparatus according to the present embodiment recognizes a mark entered in an entry column for the image data of a document read by the scanner 25, and a recognition result is displayed together with the image (document image) on the display 24, or corrects the displayed recognition result in accordance with the operation of the keyboard 22 or the mouse 23 on the computer 21. The document display device is provided to display an image of a document on the display 24. Thus, the computer 21 can also be referred to as a document processing apparatus 21.

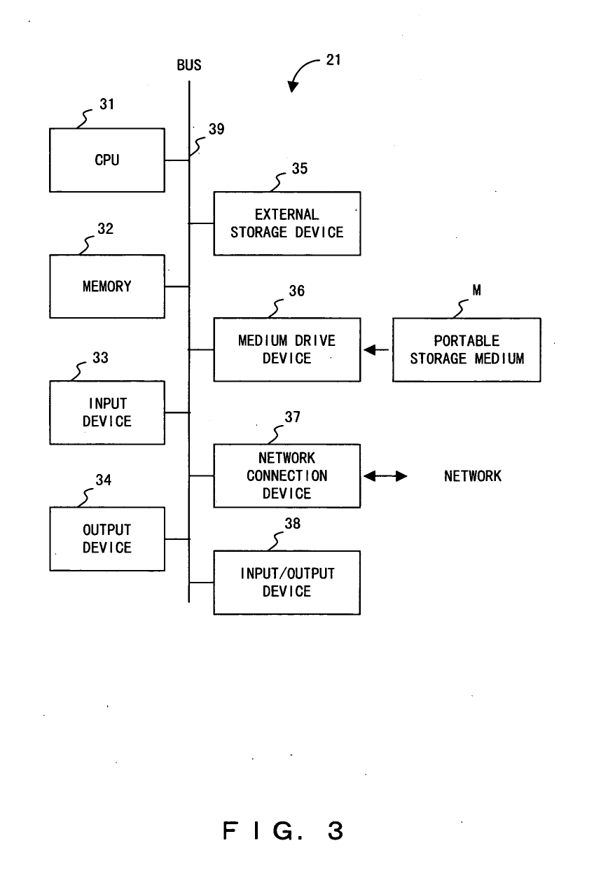

FIG. 3 shows the configuration of the computer 21.

The computer 21 has the configuration in which a CPU 31, memory 32, an input device 33, an output device 34, an external storage device (auxiliary storage device) 35, a medium drive device 36, a network connection device 37, and an input/output device 38 are interconnected through a bus 39 as shown in FIG. 3.

The memory 32 is, for example, semiconductor memory such as ROM, RAM, etc. The input device 33 is an interface which is connected to a pointing device, etc. such as the keyboard 22, the mouse 23, etc., and detects an operation performed by a user using them. The output device 34 is an interface for outputting image data for display of an image on the display 24. The external storage device 35 is, for example, a hard disk device, and stores a program executed by the CPU 31, various data, etc. The medium drive device 36 accesses a portable storage medium M such as a flexible disk, an optical disk, a magneto-optical disk, etc. The network connection device 37 is a device for communications with an external device over a communications network. The input/output device 38 is an interface for communications with an external device such as the scanner 25, etc. through a cable. The document processing apparatus 21 according to the present embodiment can be realized by, for example, the CPU 31 using hardware resources loaded into the computer 21 and by executing the program stored in the external storage device 35.

The image data of a document is read by the scanner 25 and obtained by the input/output device 38, but the network connection device 37 can also obtain the data. The display 24 can also be provided. A program stored in the external storage device 35 for realizing the document processing apparatus or the document display device according to the present embodiment has been accessed and read by the medium drive device 36 to a portable storage medium M, or has been received by the network connection device 37 through a transmission medium used in a communications network such as a public network, etc. Thus, it is clear that a user can obtain the program and realize the document processing apparatus according to the present invention using a data processing device such as a computer, etc. into which the obtained program is loaded.

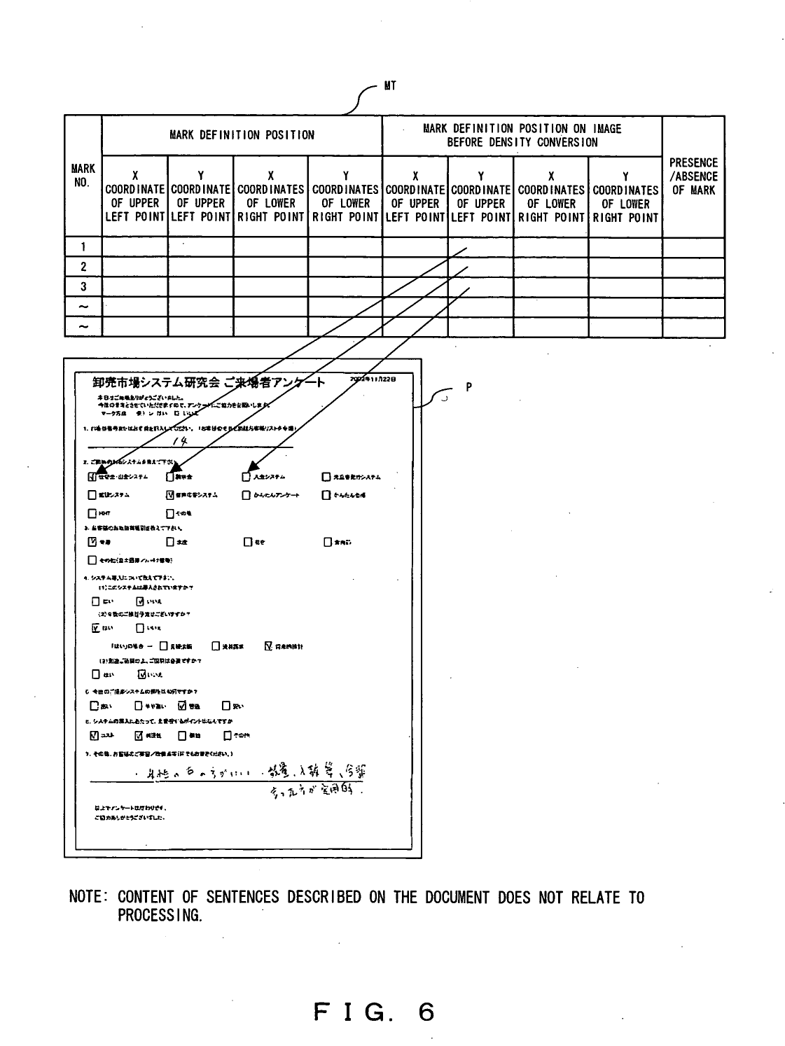

According to the embodiment of the present invention, the portion configuring an image of a document (a questionnaire form in this case) P shown in FIG. 6 is classified into at least two types of areas, that is, a useful information area considered to contain useful information in correcting a recognition result, and an useless information area considered to contain no useful information, and operates image data such that the useless information area can be displayed relatively smaller. Thus, for example, between the useful information area and the useless information area to be originally displayed in the same shape and size, the useful information area can be displayed larger. The useful information area is an area considered to include, for example, a character, a symbol, a mark entry column, a column to which a user can input characters, etc. in case the document P is a questionnaire form, for example. The useless information area is an area considered not to include them.

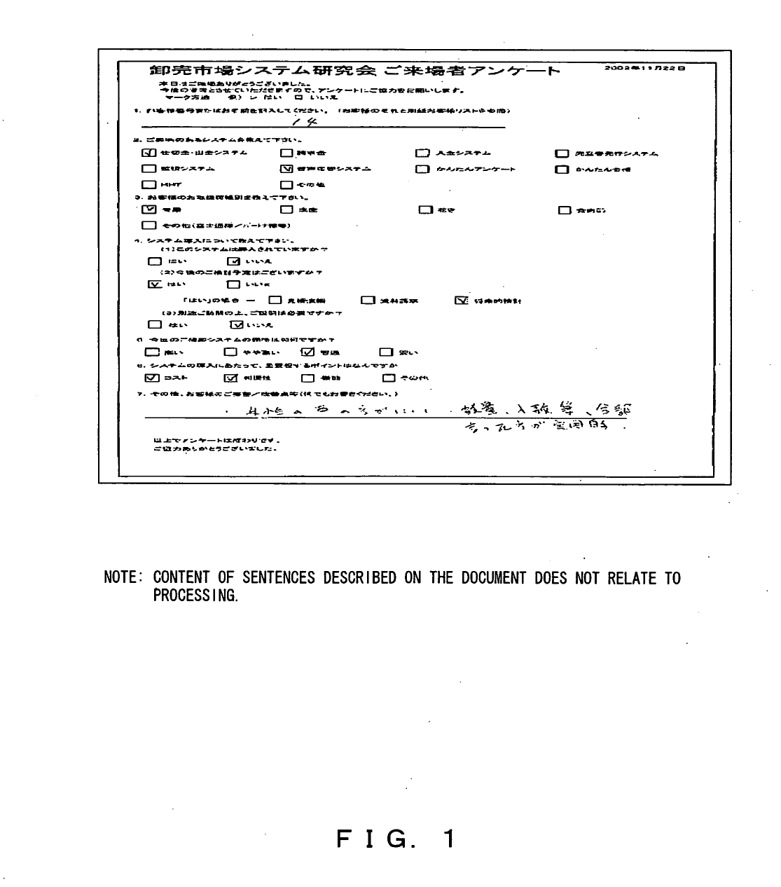

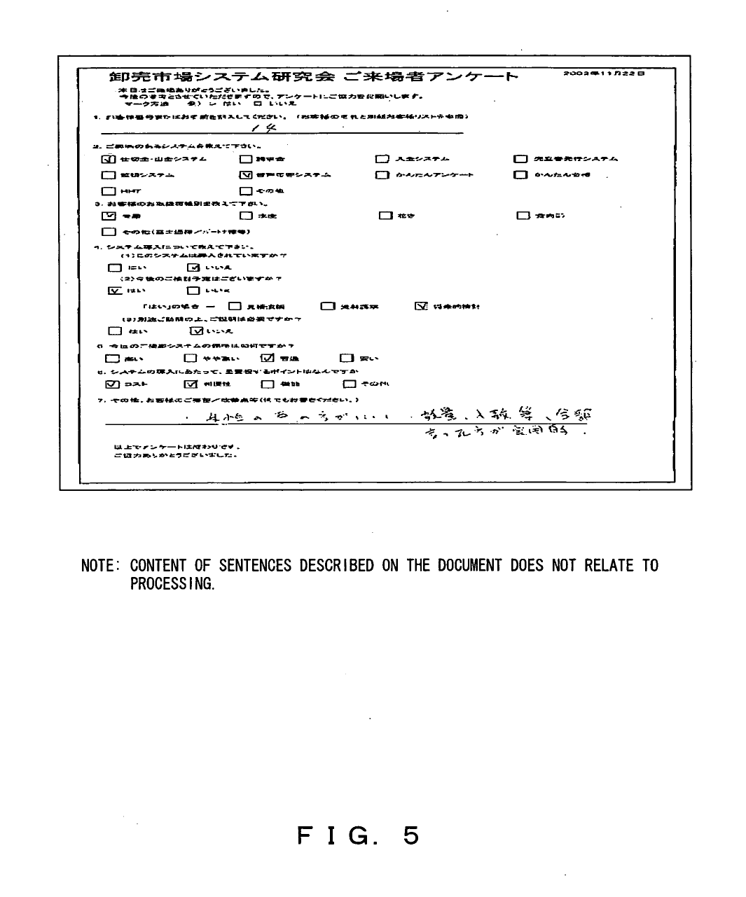

When the ratio of the useful information area to the entire image is set larger, the entire image can be displayed on one screen without reducing the entry columns of the characters, symbols, marks, etc. in the useful information area as shown in FIG. 5. Unlike the case in which an image is reduced in the vertical direction (refer to FIG. 1) (in the Y axis direction based on which rows are arranged), the reduction of visual recognizability can be successfully suppressed. Therefore, the correcting operation on a recognition result can be easily and quickly performed. Described below is the detailed description of the document processing apparatus capable of obtaining the above-mentioned effect.

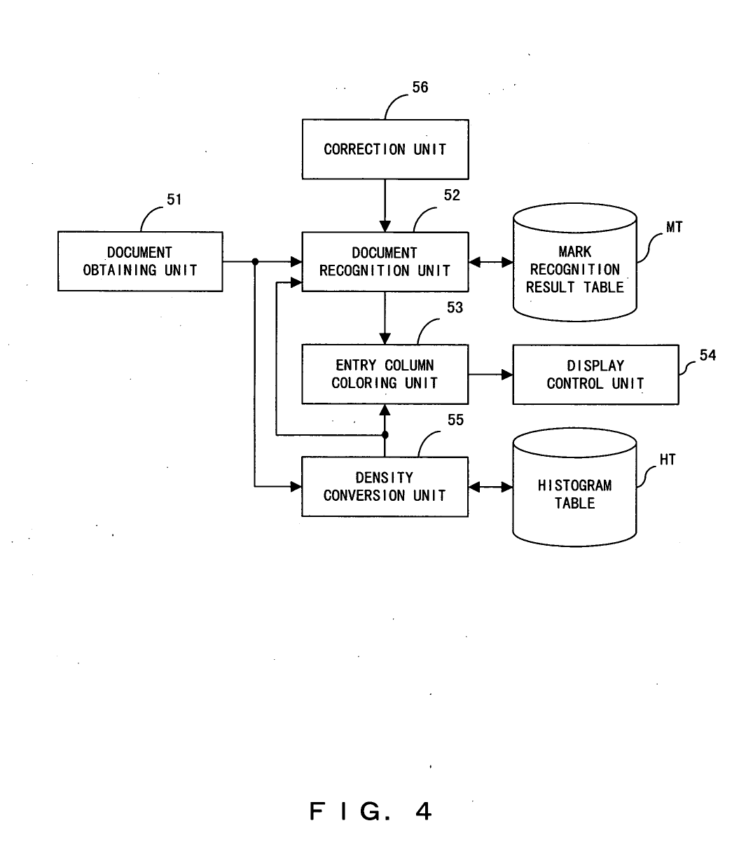

FIG. 4 shows the configuration indicating the function of the document processing apparatus 21.

As shown in FIG. 4, the document processing apparatus 21 includes: a document obtaining unit 51 for obtaining the image data of a document P; a document recognition unit 52 for recognizing an entry column to which a mark has been input by referring to the image data; an entry column coloring unit 53 for performing an operation on the image data to display an entry column recognized as containing a mark in a predetermined display color; a display control unit 54 for transmitting the image data displayed in a changed display color, and displaying the image; a density conversion unit 55 for classifying an area of the image of the document P into at least two types of areas, that is, a useful information area and an useless information area so that image data can be operated by increasing the ratio of the useful information area to the entire area; and a correction unit 56 for correcting the presence/absence of the mark on the entry column recognized by the document recognition unit 52 in accordance with an operation of the keyboard 22 or the mouse 23 by the user.

The above-mentioned document obtaining unit 51 is realized by the input/output device 38, the bus 39, the CPU 31, the memory 32, the input device 33, and the external storage device 35. The document recognition unit 52, the entry column coloring unit 53, and the density conversion unit 55 are realized by, for example, the CPU 31, the memory 32, the bus 39, and the external storage device 35. The display control unit 54 is realized by, for example, the CPU 31, the memory 32, the external storage device 35, the bus 39, and the output device 34. The correction unit 56 is realized by, for example, the CPU 31, the memory 32, the external storage device 35, the bus 39, and the input device 33.

Based on the configuration indicating the function shown in FIG. 4, the details of the operations of the document processing apparatus 21 are described below by referring to each of the explanatory views shown in FIGS. 5 through 11.

When a user operates, for example, the input device 33 to read the image of a document P, the document obtaining unit 51 transmits a command to the scanner 25 through the input/output device 38. Afterwards, when the scanner 25 transmits image data of the document P to the input/output device 38 at the transmitted command, the image data is stored in, for example, the memory 32. The image data is defined as the image data of a bit map pattern for convenience in the explanation.

The document recognition unit 52 detects and recognizes from the image data an entry column in the document and the mark input to the entry column by the well-known technology, and a recognition result is stored in a mark recognition result table MT.

The table MT is the data stored in the memory 32 or the external storage device 35. As shown in FIG. 6, a sequential number is assigned to an entry column of the document P, and the position is managed by the XY coordinates of the upper left point and the lower right point. The presence/absence of a mark can be detected by storing different values. The position of an entry column is determined by the XY coordinates of the upper left point and the XY coordinates of the lower right point because it is rectangular.

The Y axis is an axis on which rows are arranged. The X axis is an axis normal to the Y axis. In the present embodiment, the fiducial point (origin) is the upper left point of the image of the document P, and the XY coordinates are represented in the position off the fiducial point by the number of pixels. Thus, the relationship between the position of the entry column on the document and the position of the entry column on the practical image can be directly understood or represented.

The document recognition unit 52 stores the XY coordinates of the upper left point and the XY coordinates of the lower right point indicating the position of an entry column as a recognition result of the entry column in the mark recognition result table MT. Practically, it stores the values in the column of the item titled a “mark definition position of the image before density conversion”. The value indicating the presence/absence of a mark as a recognition result is stored in the column of an item titled “presence/absence of a mark”. The table MT stores the XY coordinates of the defined positions of an entry column in the column of the item titled “mark definition position” shown in FIG. 6. The detailed explanation of the data stored in the item (hereinafter referred to as “mark definition position data”) is omitted, but it is defined when the document P is generated, and the data is stored in the entry column position definition table. The table is stored in, for example, the external storage device 35.

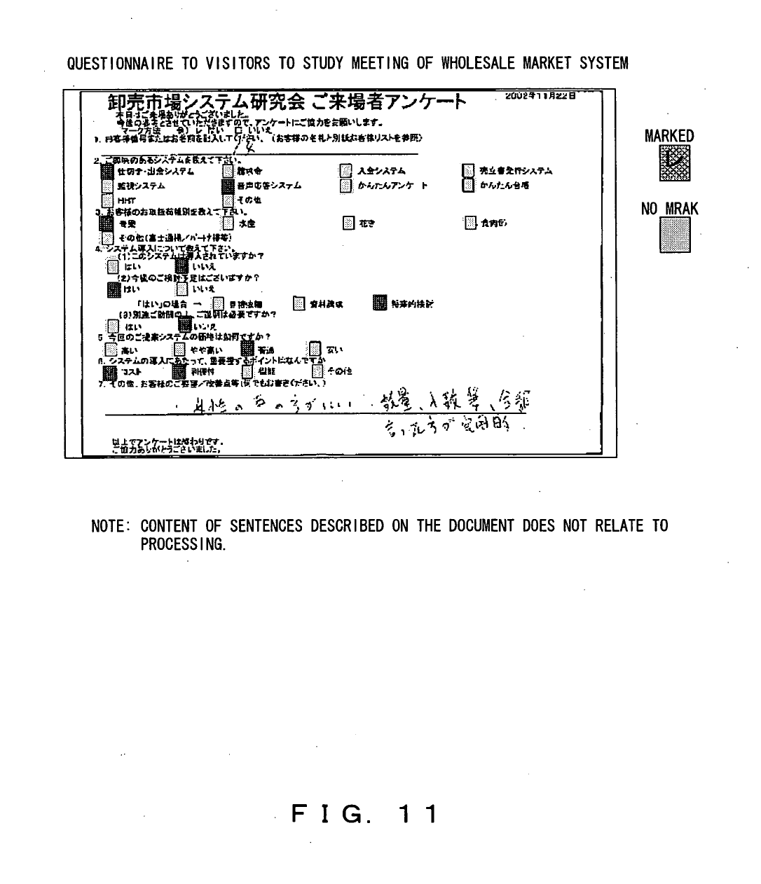

The entry column coloring unit 53 receives the image data of the document P and the mark recognition result table MT from the document obtaining unit 51, and process the image data such that an entry column recognized as containing a mark can be displayed in a predetermined display color (FIG. 11). The display control unit 54 displays the image of the document P on the display 24 by transmitting the processed image data from the output device 34 to the display 24.

The density conversion unit 55 generates a histogram table HT by referring to the image data obtained by the document obtaining unit 51, and stores the table in, for example, the memory 32. The table HT is used in classifying the area of the image of the document P into two types of areas, that is, a useful information area and an useless information area, and processing the image data such that the ratio of the useful information area to the entire area can be increased.

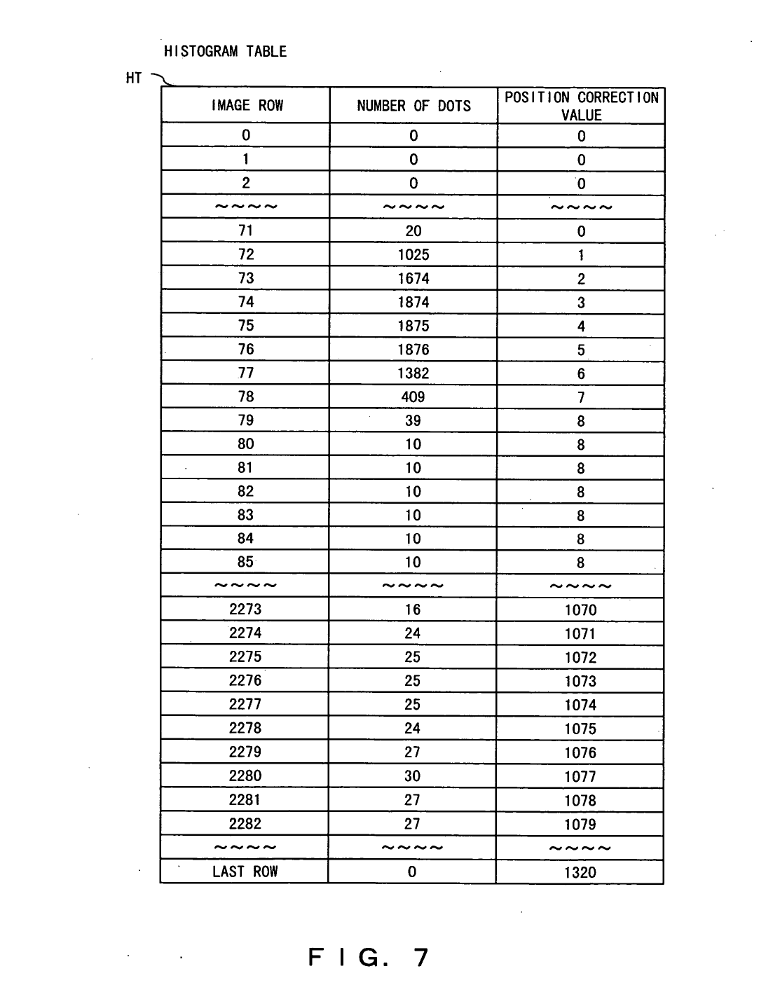

In the present embodiment, the useful information area and the useless information area are discriminated for each row (along the X axis), and the rows discriminated as belonging to the useless information area are thinned, thereby displaying the image as shown in FIG. 5. To thin the rows, the number of pixels considered to be used in displaying information is counted for each row, thereby generating a histogram. The histogram table HT is prepared to store the histogram, that is a count result for each row. As shown in FIG. 7, the table HT stores a row number in an item titled “image row” and the number of pixels as a count result in an item titled “number of dots”. An item titled “position correction value” stores a row number after the thinning operation. Only one row number is assigned to each row.

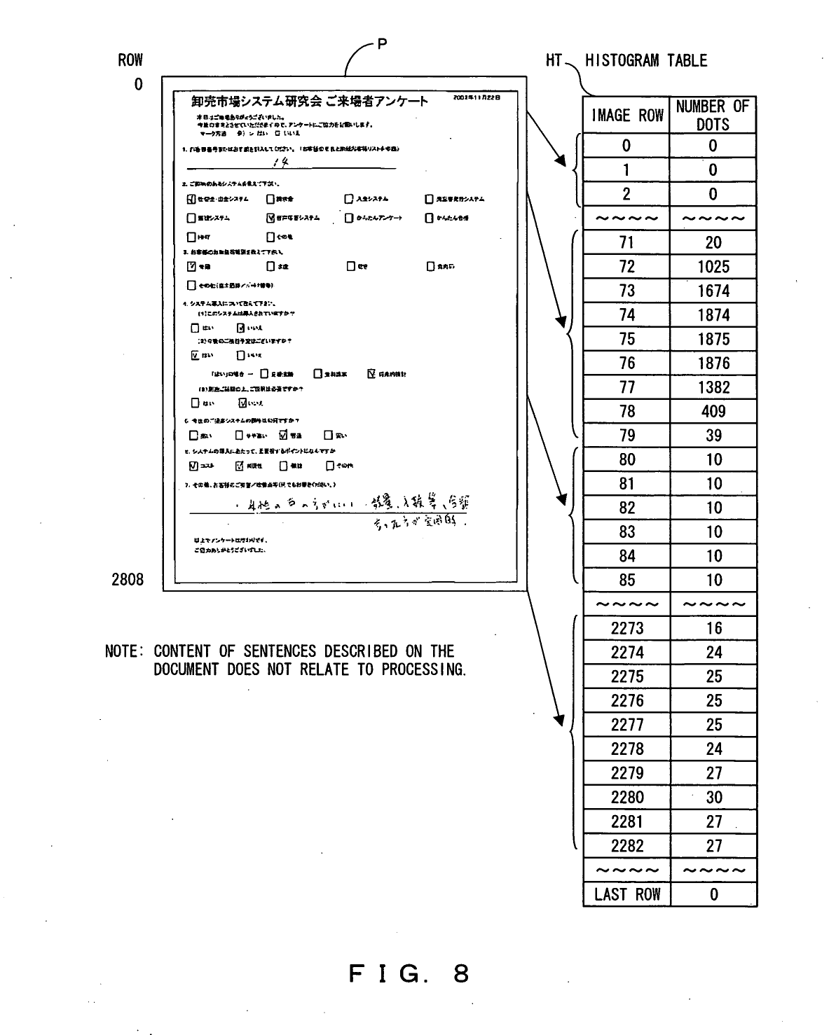

The pixel considered to be used for display of information depends on the method of capturing an image of a document P. For example, when the gray scale is read in binary, the pixel can be read as “black”. When an image is read in multivalued gray scale, the pixel can be read as having a gray scale value equal to or larger than a predetermined value. The density conversion unit 55 counts pixels for each row and stores the count result in the table HT as shown in FIG. 8.

In the row in the area containing a symbol such as a mark, a character, etc., there are normally a plurality of pixels to be counted. This is because such pixels are counted. As shown in FIG. 6, although a character is input outside the column in a document P, the range of the input character can be detected as a useful information area with high precision.

The counting process, that is, the generation of a histogram, can be easily performed. Therefore, when a histogram is used in discriminating an area, the discrimination can be performed with high precision with the load of the discriminating process reduced. Another method of discriminating an area can be used, and a plurality of methods can be combined.

When a count result is stored, each row is checked whether or not the row forms a useful information area by checking whether or not the number of pixels counted in each row sequentially from the row number of 0 is equal to or larger than a predetermined value. The value updated depending on the check result is stored as a value of the item “position correction value”. The value is updated by incrementing it when the number of pixels is equal to or larger than a predetermined value. As a result, the value as shown in FIG. 7 is sequentially stored as the value of the item. When the histogram table HT is generated as described above, the density conversion unit 55 transmits it to the document recognition unit 52.

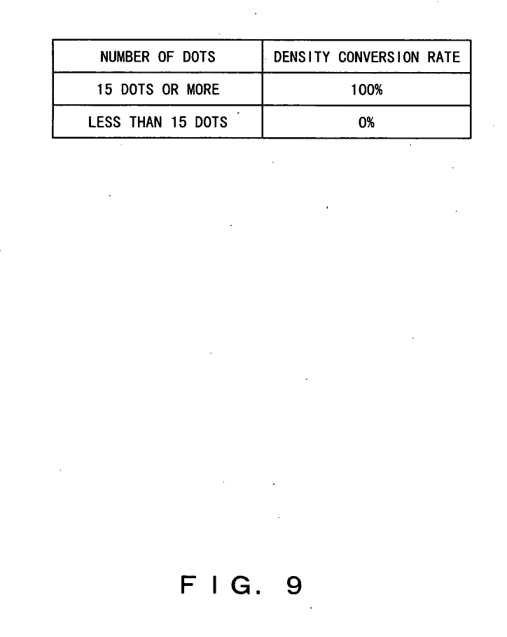

FIG. 9 is an explanatory view showing the contents of the operation depending on the method of checking a useful information area and the type of area.

As shown in FIG. 9, according to the present embodiment, the above-mentioned predetermined value, that is, the number of pixels is equal to or larger than 15 as the condition of forming a useful information area, and the density conversion rate is 100%. The density conversion rate refers to the magnification used when a useful information area is displayed. “100%” is the magnification used when an area is displayed as is while “0%” is the magnification used when an area is thinned, that is, an area is not displayed.

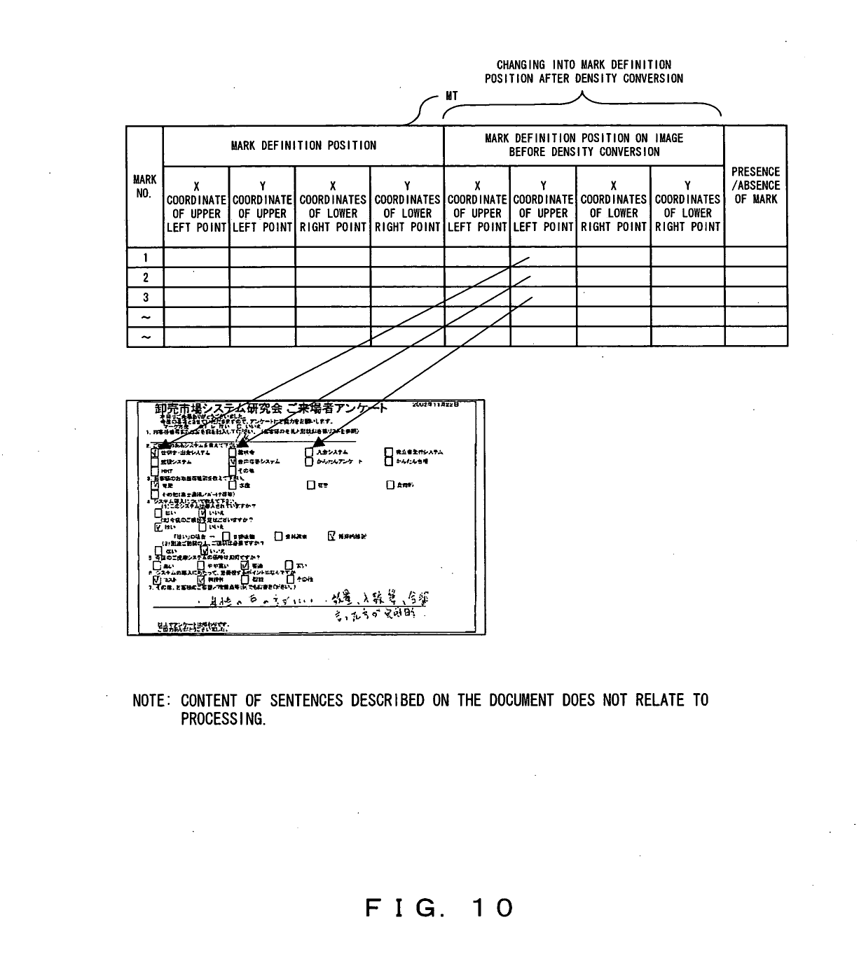

When an area is thinned, the position of an entry column in the image is changed. Therefore, the document recognition unit 52 refers to the histogram table HT received from the density conversion unit 55, and updates the mark recognition result table MT. According to the present embodiment, the thinning process is performed only for each row. Therefore, data is updated only for the Y coordinate indicating the upper left position of an entry column and the Y coordinate indicating its lower right position as shown in FIG. 10.

The row number stored in the item “position correction value” of the histogram table HT indicates the row number after the thinning process on the row of the row number of the item “image row”. Thus, the update is performed by reading a value stored in a column corresponding to the original Y coordinate of the item “position correction value”, and storing it as a new Y coordinate in the mark recognition result table MT. Thus, for examples when the original Y coordinate is “2273”, “1070” is stored as a new Y coordinate (refer to FIG. 7).

When the update is performed, the entry column coloring unit 53 receives the mark recognition result table MT again from the document recognition unit 52, and receives the histogram table HT from the density conversion unit 55. Thus, the operation of deleting data of the portion corresponding to the row forming an useless information area is performed on the image data by referring to the table MT, and the resultant image data is processed in the operation of displaying an entry column to which a mark has been input in a predetermined display color by referring to the table MT. The processed image data is transmitted to the display control unit 54, thereby displaying the image as shown in FIG. 11 on the display 24.

Thus, in the present embodiment, an entry column recognized as containing a mark is displayed in a predetermined display color so that the entry column can be more easily checked by an operator using different display colors. As a result of easily checking an entry column, the correcting operation can be more easily and quickly performed.

The correcting operation is performed by clicking the entry column in the displayed image. Thus, when the entry column recognized as containing a mark is clicked, the entry column is corrected into a column without a mark. When the entry column recognized as containing no mark is clicked, the entry column is corrected into a column containing a mark.

When a user operates the keyboard 22 or the mouse 23, the correction unit 56 interprets the contents of the instruction executed in the operation, and performs a process depending on an interpretation result. If the operation is a clicking operation on an image, the position in which the operator performed the clicking operation is specified, and the specified position is transmitted to the document recognition unit 52, and the recognition result is corrected depending on the position.

The document recognition unit 52 refers to the mark recognition result table MT, checks whether or not the position is in any entry column, and rewrites the value of the entry column corresponding to the entry column of the item “presence/absence of a mark” when the position is in an entry column. For example, assume that the value indicating the presence of a mark is “1”, and the value indicating the absence of a mark is “0”. Then, the original value of “1” is rewritten to “0”, and the original value of “0” is rewritten to “1”. After the table MT is updated by thus rewriting the values, the result is transmitted to the entry column coloring unit 53, thereby reflecting the operator corrected contents on the image displayed on the display 24. Thus, the operator corrects the recognition result while watching the image displayed on the display 24.

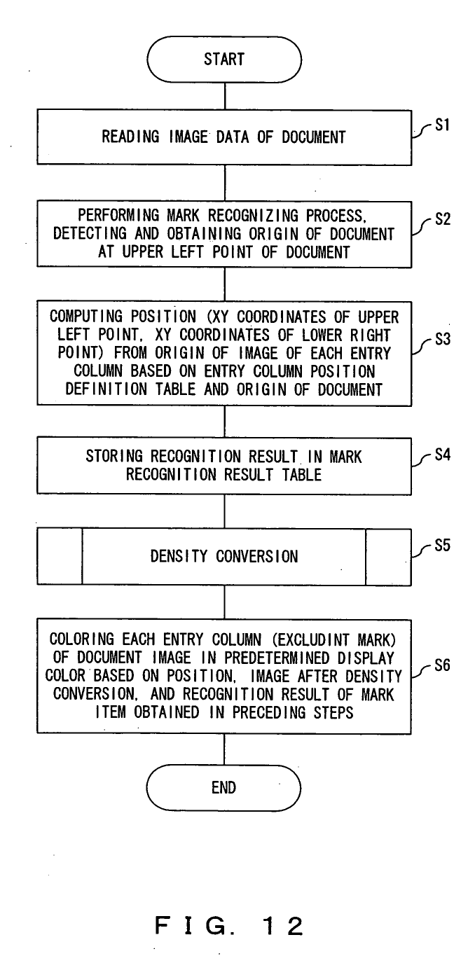

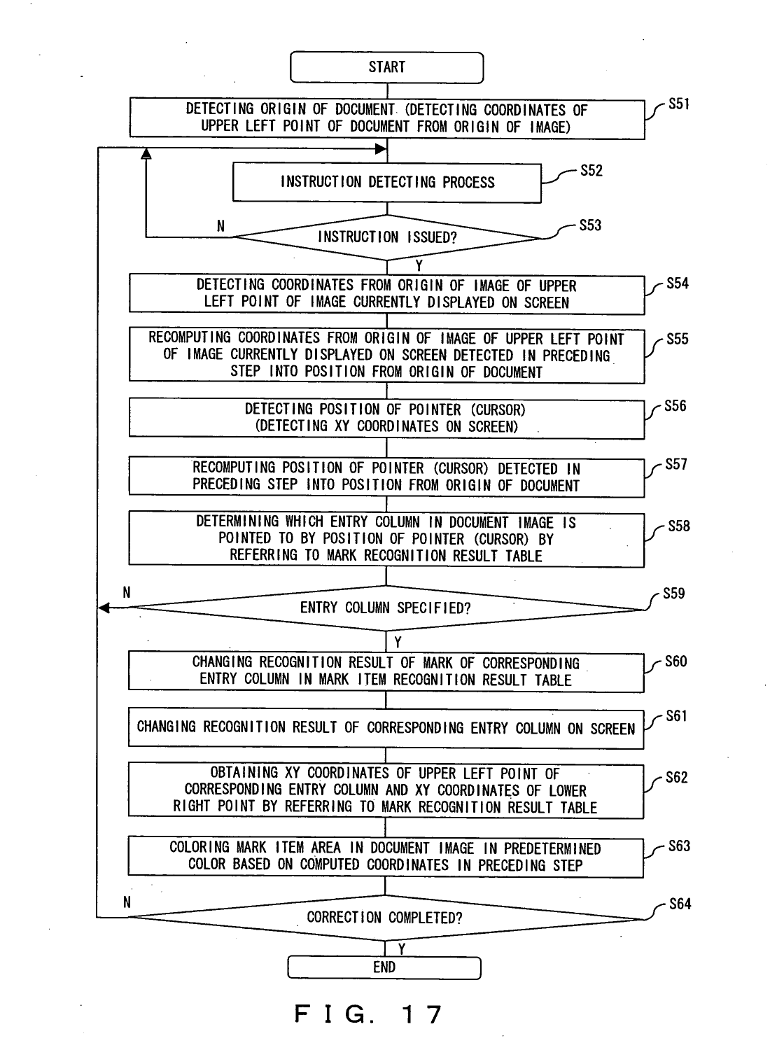

Then, the operation of the computer 21 which displays an image of a document and corrects a recognition result as described above is explained below in detail by referring to the flowcharts shown in FIGS. 12 through 17.

FIG. 12 is a flowchart of the mark recognizing process on a document. The flowchart shows the flow of the extracted processes performed from reading an image of a document P to displaying an image reflecting a mark recognition result. The flowchart shown in FIG. 12 is realized by the CPU 31 loaded into the computer 21 executing the program stored in the external storage device 35.

First, in step S1, the operator operates the keyboard 22 or the mouse 23 to specify reading an image of a document P. Then, a command is transmitted to the scanner 25 through the input/output device 38 to read the image, thereby storing the image data received by the input/output device 38 from the scanner 25 in, for example, the memory 32. In step S2, the mark recognizing process is performed to recognize the mark input to the document P, and the origin (upper left point) of the image indicated by the image data is detected. Then, control is passed to step S3.

In step S3, based on the detected origin and the mark definition position data stored in the entry column position definition table, each entry column in the image represented by the image data is recognized, and the XY coordinates of the upper left point and the upper right points indicating each entry column are computed. Then, in step S4, based on the position of the recognized entry column and the position of the recognized mark, the entry column containing a mark is recognized, and as a recognition result, the XY coordinates computed in step S3 and the mark definition position data are stored in the mark recognition result table MT (FIG. 6). Then, control is passed to step S5.

In step S5, the number of pixels considered to be used for display of information is counted for each row of an image indicated by image data. The count result, and the row number after thinning the rows forming an useless information area are stored in the histogram table HT (refer to FIG. 7). By referring to the table HT, the density converting process of updating the Y coordinate stored in the mark recognition result table MT is performed. In the next step S6, based on the histogram table HT generated in step S5, and the updated mark recognition result table MT, the operation of thinning the rows forming the useless information area and the operation of displaying the entry column recognized as containing a mark in a predetermined display color are performed on the image data. After the operations, the obtained image data is transmitted from the input/output device 38 to the display 24, thereby displaying the image of the document P as shown in FIG. 11. After displaying the image, a series of processes terminates.

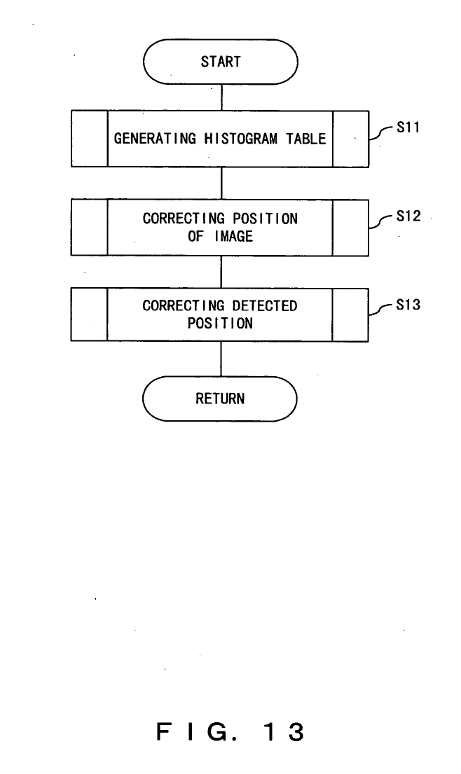

The density converting process performed in step S5 is described below in detail by referring to the flowchart shown in FIG. 13.

First, in step S11, the histogram table generating process of generating a histogram table HT is performed by counting the number of pixels considered to be used for display of information for each row of an image indicated by image data. In step S12, the image position correcting process of storing the value of the item “position correction value” in the generated histogram table HT is performed. In the next step S13, the detection position correcting process of updating the mark recognition result table MT by referring to the histogram table HT (refer to FIG. 7) completed by storing the value of the item “position correction value” is performed, thereby terminating the series of processes.

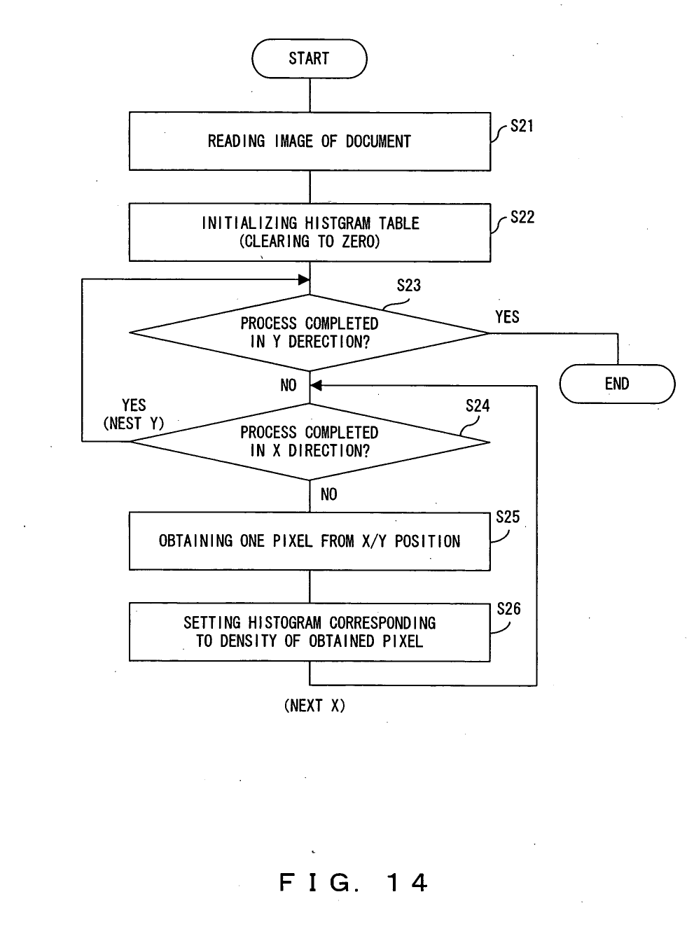

Then, the each subroutine process performed in the above-mentioned steps S11 through S13 is described below in detail by referring to various flowcharts shown in FIGS. 14 through 16.

FIG. 14 is a flowchart of the histogram table generating process performed in step S11. In the subroutine process performed in the density converting process, FIG. 14 is first referred to, and the process of generating the histogram is explained below in detail.

First, in step S21, the image data of the document P read in step S1 shown in FIG. 12 is copied to, for example, the memory 32. In the next step S22, the area storing the histogram table HT is reserved in, for example, the memory 32, and each value is cleared (to zero). The process is performed by, for example, defining an array variable, and substituting 0 for all elements forming it.

As described above, the number of pixels considered to be used for display of information is counted for each row starting from the row having the row number of 0. Thus, in step S23 to be performed after step S22, it is determined whether or not the process in the Y direction has been completed, that is, whether or not the number of pixels has been counted up to the last row. If the number of pixels is counted up to the last row, the determination is YES, thereby terminating the series of processes. Otherwise, the determination is NO, and control is passed to step S24.

In step S24, it is determined whether or not the process in the X direction has been completed, that is, the number of pixels in a target row has been counted. If the number has been counted, the determination is YES, and control is passed to the row having the row number larger by 1 than the previous target row, and the process in step S23 is performed. Otherwise, the determination is NO, and control is passed to step S25.

In step S25, the data of a target pixel in the target row is obtained from the image data. In step S26, it is determined based on the obtained pixel data whether or not it is a pixel considered to be used for display of information. Depending on the determination result, the value of the column corresponding to the target row of the item “number of dots” is updated. If the target pixel is located at the head of a row, then the row number is stored in the corresponding column of the item “image row” After the update, a target pixel is changed into the pixel located to the right, and control is returned to step S24.

By repeatedly performing the process loop formed by steps S24 through S26 until the determination in step S24 turns to YES, the number of pixels considered to be used for display of information is counted and the result is stored in the histogram table HT. Therefore, when the process loop formed by steps S23 through S26 is repeatedly performed until the determination in step S23 turns to YES, then the number of pixels counted in all rows is stored in the table HT.

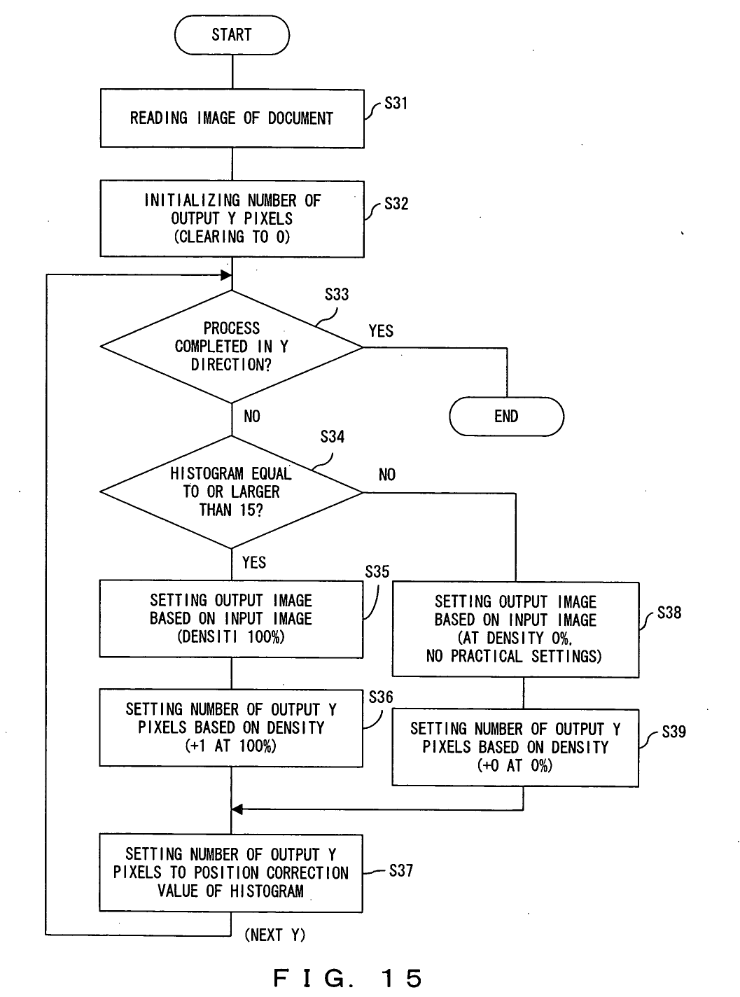

FIG. 15 is a flowchart of the image position correcting process performed in step S12 in the density converting process shown in FIG. 13. Then, the correcting process is explained below in detail by referring to FIG. 15.

First, in step S31, the image data of the document P read in step S1 shown in FIG. 12 is copied to, for example, the memory 32. In the next step S32, the number of output Y pixels which is a variable for management of the value stored in the column of the item “position correction value” is initialized, and the value is set to 0, thereby passing control to step S33.

In step S33, it is determined whether or not the process in the Y direction has been completed, that is, whether or not the row numbers have been stored up to the last row after the thinning operation is applied to the rows. If the row number of the last row has been stored in the table HT after the thinning operation is applied to the rows, the determination turns to YES, thereby terminating the series of processes. Otherwise, the determination is NO, and control is passed to step S34.

In step S34, it is determined whether or not the number of pixels counted in the target row is equal to or larger than 15. If the number of pixels is smaller than 15, then the determination turns to NO, and control is passed to step S38. Otherwise, that is, is the number of pixels is equal to or larger than 15, then the determination is YES, and control is passed to step S35.

In step S35, the target row is set as the row in which the image is displayed at the density (magnification) of 100%. In step S36, based on the setting, the number of output Y pixels, which is a variable, is incremented. In step S37 to which control is passed after the increment, the value of the number of output Y pixels is stored in the column corresponding to the target row of the item “position correction value”. After the storage, control is changed to the row having the row number larger by 1 than the previous target row, thereby returning control to step S33.

In step S38, the target row is set as a row in which an image is displayed at the density (magnification) of 0%. In the next step S39, based on the setting, the number of output Y pixels which is a variable is unchanged. Thus, in the next step S37, the row number set for the target row immediately before is stored in the table HT.

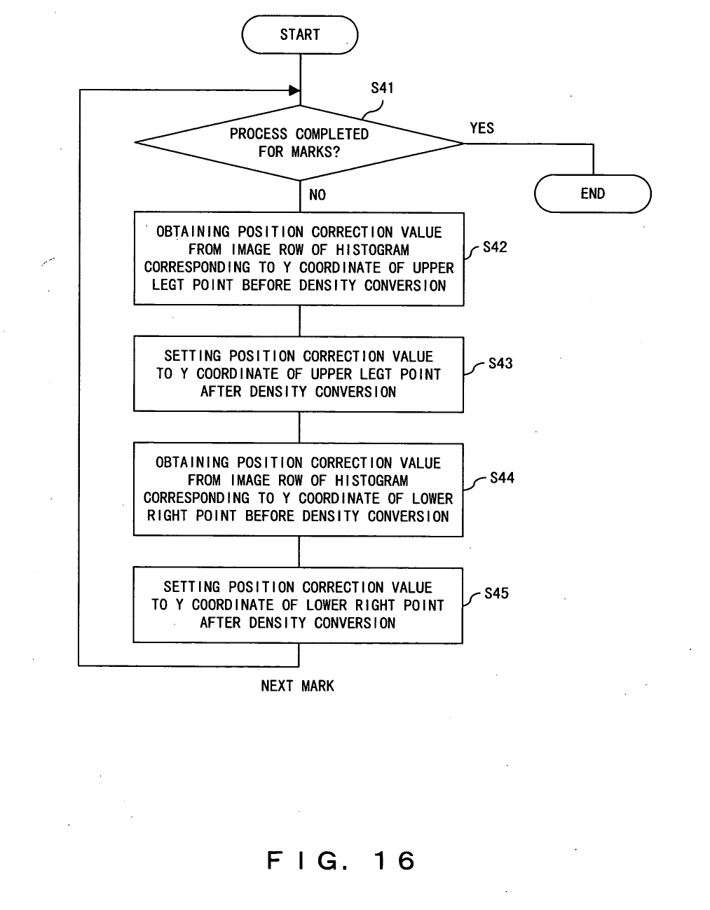

Finally, the detection position correcting process performed in step S13 in the density converting process shown in FIG. 13 is described below in detail by referring to the flowchart shown in FIG. 16.

First, in step S41, it is determined whether or not the process on the mark entry column has been completed, that is, whether or not all the Y coordinates in the entry column have been updated. If the update has been completed, the determination is YES, thereby terminating the series of processes. Otherwise, the determination is NO, and control is passed to step S42.

In step S42, the Y coordinate of the upper left point of the target entry column is read from the mark recognition result table MT, and the value (row number after the thinning operation is applied to the rows) of the column corresponding to the Y coordinates of the item “position correction value” is obtained by referring to the histogram table HT. In the next step S43, the obtained value is stored as the new Y coordinate of the upper left point of the target entry column in the mark recognition result table MT. In the next steps S44 and S45, the target is changed into the Y coordinate of the lower right point, and the Y coordinate is similarly updated. After updating the Y coordinate of the lower right point in step S45, the target entry column is changed to the next target entry column, and control is returned to step S41.

Thus, when the density converting process is performed, a histogram table HT (refer to FIG. 7) is generated, and a mark recognition result table MT is updated by referring to the table HT. By performing the operations on the image data of the document P using the tables MT and HT, the image as shown in FIG. 11 is displayed on the display 24.

A recognition result is corrected by operating an image displayed on the display 24, that is, by clicking the entry column as described above. Next, the correcting process of realizing the correction is explained below in detail by referring to the flowchart shown in FIG. 12. The correcting process is performed after the mark recognizing process performed on the document as shown in FIG. 12.

First, in step S51, the origin (upper left point) of the image of the document P displayed on the display 24 by the image data transmitted through the input/output device 38 is detected. Then, in step S52, the instruction detecting process of detecting an instruction issued by the operator by operating the keyboard 22 or the mouse 23 is performed.

In the next step S53, it is determined whether or not an instruction has been detected by performing the instruction detecting process. When neither the keyboard 22 nor the mouse 23 is operated, or when the operator does not perform an operation related to an instruction, the determination is NO, and control is returned to step S52. Thus, an instruction from the operator is awaited. Otherwise, the determination is YES, and control is passed to step S54. In this case, it is assumed for convenience that the operation related to an instruction is a clicking operation on an image.

In step S54, the coordinates from the origin at the upper left point of the image of the portion currently displayed on the screen are detected. In the next step S55, the coordinates from the detected origin are set as the coordinate of the upper left point of the image of the portion. After the setting, the position (cursor position) in which the operator has clicked is detected (step S56), the coordinates from the origin of the image corresponding to the position is computed (step S57), and the entry column including the computed position is determined (step S58) referring to mark recognition result table MT. Then, control is passed to step S59.

In step S59, it is checked whether or not the position in which the operator has clicked is in an entry column. If the operator has clicked with the cursor moved into any entry column, then the determination is YES, and control is passed to step S60. Otherwise, the determination is NO, and control is returned to step S52. Thus, the process is prepared for an instruction next issued by the operator.

In step S60, the recognition result corresponding to the entry column clicked by the operator in the mark recognition result table MT is changed. In step S61, the recognition result in the entry column in the image displayed on the display 24 is changed. If a mark has been displayed, it is removed. If a mark has not been displayed, a mark is newly displayed. The mark is displayed by arranging the image data for use in displaying a mark prepared in advance in the corresponding position in the entry column of the image data of the document P, and by transmitting the arranged image data to the display 24.

In step S62 performed after step S61, the XY coordinates of the upper left point and the lower right point of the entry column are obtained by referring to the mark recognition result table MT. In step S63, the operation of displaying the entry column in the display color based on the presence/absence of a mark is performed on the image data. In the next step S64, it is determined whether or not the operator has issued an instruction to terminate the correcting process. If the operator has issued the instruction, then the determination is YES, thereby terminating the series of processes. Otherwise, the determination is NO, and control is returned to step S52.

In the present embodiment, the ratio of the useful information area to the entire area is increased by thinning the rows forming an useless information area. However, the increment of the ratio can be performed in other methods. For example, the ratio can be increased using different display magnification (density) when the areas are displayed, that is, setting different sizes of display areas assigned to the same amount of data (number of pixels). In this case, for example, the ratio can be increased by magnifying only a useful information area when the areas are displayed. To realize this, the operation can be performed based on the result of determining whether or not the image of the document P can be displayed on one screen.

Furthermore, although an area is classified into two types of areas, that is, a useful information area and an useless information area according to the present embodiment, the area can be classified into a larger number of areas. For example, an area can be classified into more than three types of areas depending on. the possibility that useful information is contained, and different magnification (density) can be set for each type of area.

As described above, according to the present invention, an area on the document image indicated by obtained image data is discriminated, and is classified into at least two areas, that is, a useful information area having useful information for processing a document and an useless information area having no useful information. In the image data, a process is performed on at least one of the first partial image data which is image data of the portion displaying a useful information area and the second partial image data which is image data of the portion displaying an useless information area such that the ratio of the useful information area to the entire area can be changed. Using the processed image data, the document image is displayed on the display device. Therefore, most part of the useful information area can be displayed. As a result, the correcting operation, etc. of a mark recognition result can also be more easily and quickly performed.

1. A document processing apparatus which displays a document image using image data of a document having one or more entry columns, comprising:
an image data obtaining unit obtaining image data of a document;
an area discrimination unit discriminating an area of a document image indicated by the image data obtained by said image data obtaining unit, and discriminating at least between two types of areas, that is, a useful information area having useful information for document processing and an useless information area having no useful information area;
a data processing unit increasing a ratio of the useful information area to the entire area by processing at least one of a first partial image data which is image data of a portion for display of the useful information area and a second partial image data which is image data of a portion for display of the useless information area based on the discrimination by said area discrimination unit; and
a display control unit displaying a document image on a display device using the image data obtained by said data processing unit processing at least one of the first and second partial image data.

2. The apparatus according to claim 1, wherein
said area discrimination unit considers at least one direction in counting a number of pixels assumed to be used in displaying information about a document image represented by the image data, and discriminates the useful information area from the useless information area based on a counting result.

3. The apparatus according to claim 2, wherein
when said area discrimination unit discriminates the useful information area from the useless information area based on whether or not the number of pixels counted by considering one direction is equal to or smaller than a predetermined value, said data processing unit increases a ratio of the useful information area to the entire area by performing on at least the second partial image data a process of thinning lines having the number of pixels equal to or smaller than a predetermined value in the lines in the one direction.

4. The apparatus according to claim 1, wherein
said data processing unit performs a process on at least one of the first and second partial image data so that a ratio of the useful information area to the entire area can be increased by using different display magnifications of the useful information area and the useless information area.

5. A method for displaying a document image using image data of a document having one or more entry columns, comprising:
discriminating an area of a document image indicated by the image data of the document, and discriminating at least between two types of areas, that is, a useful information area having useful information for document processing and an useless information area having no useful information area;
increasing a ratio of the useful information area to the entire area by processing at least one of a first partial image data which is image data of a portion for display of the useful information area and a second partial image data which is image data of a portion for display of the useless information area based on the discrimination; and
displaying the document image on a display device using the image data obtained by processing at least one of the first and second partial image data.

6. A document processing apparatus which processes a document having one or more entry columns, comprising:
image data obtaining unit obtaining image data of a document;
area discrimination unit discriminating an area of a document image indicated by the image data obtained by said image data obtaining means, and discriminating at least between two types of areas, that is, a useful information area having useful information for document processing and an useless information area having no useful information area;
data processing unit increasing a ratio of the useful information area to the entire area by processing at least one of a first partial image data which is image data of a portion for display of the useful information area and a second partial image data which is image data of a portion for display of the useless information area based on the discrimination by said area discrimination means;
display control unit displaying a document image on a display device using the image data obtained by said data processing means processing at least one of the first and second partial image data;
document recognition unit recognizing the entry column entered on the document image displayed by said display control means; and
correction unit correcting presence/absence of an entry in the entry column recognized by said document recognition means at an instruction of a user.

7. A storage medium storing a program used to direct a document processing apparatus which displays a document image using image data of a document having one or more entry columns, comprising the functions of:
obtaining image data of the document;
discriminating an area of a document image indicated by the image data obtained by said obtaining function, and discriminating at least between two types of areas, that is, a useful information area having useful information for document processing and an useless information area having no useful information area;
increasing a ratio of the useful information area to the entire area by processing at least one of a first partial image data which is image data of a portion for display of the useful information area and a second partial image data which is image data of a portion for display of the useless information area based on the discrimination by said discriminating function; and
displaying the document image on a display device using the image data obtained by processing at least one of the first and second partial image data by said increasing function.

8. A storage medium storing a program used to direct a document processing apparatus which processes a document having one or more entry columns, comprising the functions of:
obtaining image data of the document;
discriminating an area of a document image indicated by the image data obtained by said obtaining function, and discriminating at least between two types of areas, that is, a useful information area having useful information for document processing and an useless information area having no useful information area;
increasing a ratio of the useful information area to the entire area by processing at least one of a first partial image data which is image data of a portion for display of the useful information area and a second partial image data which is image data of a portion for display of the useless information area based on the discrimination by said discriminating function;
displaying the document image on a display device using the image data obtained by processing at least one of the first and second partial image data by said increasing function;
recognizing the entry column entered on the document image displayed by said display control means; and
correcting presence/absence of an entry in the entry column recognized by said document recognition means at an instruction of a user.

9. A document processing apparatus which displays a document image using image data of a document having one or more entry columns, comprising:
an image data obtaining means for obtaining image data of a document;
an area discrimination means for discriminating an area of a document image indicated by the image data obtained by said image data obtaining unit, and discriminating at least between two types of areas, that is, a useful information area having useful information for document processing and an useless information area having no useful information area;
a data processing means for increasing a ratio of the useful information area to the entire area by processing at least one of a first partial image data which is image data of a portion for display of the useful information area and a second partial image data which is image data of a portion for display of the useless information area based on the discrimination by said area discrimination unit; and
a display control means for displaying a document image on a display device using the image data obtained by said data processing unit processing at least one of the first and second partial image data.

10. A document processing apparatus which processes a document having one or more entry columns, comprising:
image data obtaining means for obtaining image data of a document;
area discrimination means for discriminating an area of a document image indicated by the image data obtained by said image data obtaining means, and discriminating at least between two types of areas, that is, a useful information area having useful information for document processing and an useless information area having no useful information area;
data processing means for increasing a ratio of the useful information area to the entire area by processing at least one of a first partial image data which is image data of a portion for display of the useful information area and a second partial image data which is image data of a portion for display of the useless information area based on the discrimination by said area discrimination means;
display control means for displaying a document image on a display device using the image data obtained by said data processing means processing at least one of the first and second partial image data;
document recognition means for recognizing the entry column entered on the document image displayed by said display control means; and
correction means for correcting presence/absence of an entry in the entry column recognized by said document recognition means at an instruction of a user.
